(19) United States
(12) Patent Application Publication
(10) Pub. No.: US 2025/0111402 A1
(43) Pub. Date: Apr. 3, 2025

(54) COMPUTER-BASED QUESTION-ANSWERING SYSTEM USING MULTIPLE TYPES OF USER FEEDBACK

(71) Applicant: INTERNATIONAL BUSINESS MACHINES CORPORATION, Armonk, NY (US)

(72) Inventor: Djallel Bouneffouf, Poughkeepsie, NY (US)

(21) Appl. No.: 18/343,733

(22) Filed: Jun. 28, 2023

(51) Int. Cl. G06Q 30/0217

(52) U.S. Cl. CPC G06Q 30/0217

(57) ABSTRACT

A computer-based question-answering system is capable of receiving a user input specifying a noisy reward and a sparse reward. The noisy reward and the sparse reward are received responsive to an initial recommendation generated by a computer-based recommendation system. A filtered noisy reward is generated by filtering the noisy reward based on an upper bound for the sparse reward or a lower bound for the sparse reward. A final reward is generated based on the filtered noisy reward and the sparse reward. An expected reward and a confidence interval for each of a plurality of candidate recommendations are updated based on the final reward. A subsequent recommendation generated by the computer-based recommendation system is provided based on the expected reward as updated and the confidence interval as updated for each candidate recommendation of the plurality of candidate recommendations.

### BACKGROUND

This disclosure relates to computer-based question-answering systems.

Question-answering (QA) refers to a field of computer science that seeks to build computer-based systems that are capable of automatically responding to received user questions. A QA system is capable of receiving a user input posing or specifying some type of question and automatically generating an answer or response derived from one or more data sources. QA systems are used in a variety of different types of practical applications that can include, but are not limited to, chatbots, virtual assistants, automated customer service systems, automated technical support systems, product recommendation systems, and any of a variety of other automated systems that interact with users. The QA systems are responsible for the selection of a particular response that is provided to the user.

In general, a computer-based QA system executes a framework that is capable of performing sequential decision making. The QA system chooses a “best” action to perform at each iteration. In doing so, the QA system attempts to maximize a cumulative reward that is provided over a period of time. The QA system also performs exploration of new actions (responses/recommendations). An ongoing challenge in designing QA systems that directly affects the Quality of Result (QoR) obtained from the system is balancing exploration of new actions (referred to as “exploration”) with the selection of known actions (referred to as “exploitation”). The reward handling mechanisms of existing QA systems do not take into consideration all available user feedback and, as such, may lead to situations in which the QA system provides responses that are non-responsive or less relevant to the user's inquiry or the current context.

### SUMMARY

In one or more embodiments, a method includes receiving, via an interface of a data processing system, a user input specifying a noisy reward and a sparse reward. The noisy reward and the sparse reward are received responsive to an initial recommendation generated by a computer-based recommendation system. The method includes generating a filtered noisy reward by filtering, using a reward filter executable by a processor of the data processing system, the noisy reward based on an upper bound for the sparse reward or a lower bound for the sparse reward. The method includes generating, using the processor, a final reward based on the filtered noisy reward and the sparse reward. The method includes updating, by the computer-based recommendation system, an expected reward and a confidence interval for each of a plurality of candidate recommendations based on the final reward. The method includes providing, via the interface, a subsequent recommendation generated by the computer-based recommendation system based on the expected reward as updated and the confidence interval as updated for each candidate recommendation of the plurality of candidate recommendations.

The foregoing and other implementations can each optionally include one or more of the following features, alone or in combination. Some example implementations include all the following features in combination.

In some aspects, the filtering includes at least one of: in response to determining that the noisy reward is less than the lower bound of the sparse reward, updating the noisy reward to be equal to the lower bound of the sparse reward; or, in response to determining that the noisy reward is greater than the upper bound of the sparse reward, updating the noisy reward to be equal to the upper bound of the sparse reward.

In some aspects, the final reward is generated based on the filtered noisy reward and the sparse reward includes summing the final reward with the filtered noisy reward.

In some aspects, the method includes generating a recommendation for each of a plurality of iterations. For one or more of the plurality of iterations, a sparse reward is not received. Accordingly, the method includes, for each iteration in which a sparse reward is not received, using the noisy reward, as filtered, as the final reward.

In some aspects, the method includes updating an expected sparse reward for each iteration. The method includes updating a confidence interval for the sparse reward for each iteration. The method also includes using the expected sparse reward as updated and the confidence interval for the sparse reward as updated in performing the filtering for each respective iteration.

In some aspects, each of the initial recommendation and the subsequent recommendation is generated by the computer-based recommendation system based on a respective context vector.

In one or more embodiments, a method includes generating, by a processor, an initial recommendation selected from a plurality of candidate recommendations based, at least in part, on an expected reward for each candidate recommendation. The method includes receiving, by the processor, user feedback corresponding to the initial recommendation. The user feedback specifies a noisy reward and a sparse reward. The method includes constraining, by the processor, the noisy reward to be within a defined range of the sparse reward. The method includes generating, by the processor, a final reward based on the noisy reward as constrained and the sparse reward. The method includes selecting, by the processor, a subsequent recommendation from the plurality of candidate recommendations based, at least in part, on an updated expected reward for each candidate recommendation, wherein the updated expected reward is determined based on the final reward.

The foregoing and other implementations can each optionally include one or more of the following features, alone or in combination. Some example implementations include all the following features in combination.

In some aspects, the method includes generating a recommendation for each of a plurality of iterations. For one or more of the plurality of iterations, a sparse reward is not received. The method includes, for each iteration in which a sparse reward is not received, using the noisy reward, as constrained, as the final reward.

In some aspects, the constraining includes at least one of: in response to determining that the noisy reward is less than a lower bound of the sparse reward, updating the noisy reward to be equal to the lower bound of the sparse reward; or, in response to determining that the noisy reward is greater than an upper bound of the sparse reward, updating the noisy reward to be equal to the upper bound of the sparse reward.

In some aspects, for each of a plurality of iterations, the lower bound of the sparse reward is updated and the upper bound of the sparse reward is updated. The constraining constrains the noisy reward during each iteration using the lower bound or the upper bound as updated for the iteration.

In some aspects, each of the initial recommendation and the subsequent recommendation is generated, by the processor, based on a respective context vector.

In one or more embodiments, a system includes one or more processors configured to initiate and/or perform executable operations as described within this disclosure.

In one or more embodiments, a computer program product includes a computer readable storage medium having program instructions stored thereon. The program instructions are executable by one or more processors to cause the one or more processors to execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computer-based Question-Answering (QA) system in accordance with the inventive arrangements described within this disclosure.

FIG. 2 illustrates an example of a QA framework that is executable by the system of FIG. 1.

FIG. 3 is an example method illustrating certain operative features of the QA system described in connection with FIGS. 1 and 2.

FIG. 4 is another example method illustrating certain operative features of the QA system described in connection with FIGS. 1 and 2.

### DETAILED DESCRIPTION

This disclosure relates to computer-based question-answering (QA) systems (hereafter “QA system”). A QA system is configured to sequentially choose a recommendation from among a plurality of candidate recommendations. The QA system is capable of presenting the chosen recommendation to a user. As discussed, for QA systems that implement sequential decision making, balancing exploration and exploitation is an ongoing challenge in achieving a high Quality of Result (QoR). A high QoR refers to the QA system providing better or more accurate recommendations or predictions to the user. Within this disclosure, the term “recommendation” is used. A recommendation is an automated response provided by the QA system. In general, the recommendation is a prediction of a future interaction between a particular user with a given system in which the QA system is integrated or a part.

The exploration versus exploitation problem may be formulated as a multi-armed bandit (MAB) problem where, given a set of bandit “arms” (e.g., actions or candidate recommendations), where each arm is associated with a fixed but unknown reward probability distribution, the QA system selects an arm to play at each iteration. A reward is drawn according to the selected arm's distribution independently from the previous actions. Another version of the MAB problem is referred to as the contextual MAB problem. In the contextual MAB problem, at each iteration, before choosing an arm, the QA system observes a particular context. In the contextual MAB problem, as the QA system operates, the goal is to learn the relationship between the context and the rewards to improve the QoR.

In accordance with the inventive arrangements described within this disclosure, a QA system is disclosed that incorporates multiple, different types of user feedback. The different types of user feedback may be used in the service of a single goal, e.g., providing the user with recommendations that are relevant or highly relevant to the user's inquiry and/or context. One type of user feedback, also referred to herein as a “reward,” is a “noisy reward.” An example of a noisy reward includes a user selection of a recommendation as provided from the QA system. The act of the user selecting the recommendation indicates to the QA system a level of interest by the user in the recommendation as selected. The level of interest conveys a quantifiable metric to the QA system as to the accuracy or efficacy of the recommendation provided.

Another type of user feedback is a “sparse reward.” A sparse reward has a reduced probability of occurring or being received by the QA system compared to a noisy reward. Though received less often, the sparse reward provides more concrete or accurate feedback from the user to the QA system with regard to a QA system generated recommendation. An example of user feedback considered a sparse reward is a user rating of a QA system generated recommendation.

In one or more embodiments, the example QA systems disclosed herein use and incorporate both noisy rewards and sparse rewards to choose a recommendation that is provided to the user. In executing a framework that uses both types of user feedback, the example QA systems are able to provide improved QoR in terms of the recommendations generated. Moreover, in using both noisy rewards and sparse rewards, the example QA systems disclosed herein leverage the different types of real-world user feedback actually available in a variety of different types of real-world applications.

In addition to providing more relevant responses to user questions and/or contexts, achieving an improved QoR of for QA system provides other practical benefits that directly relate to the operation of the computing environment in which the QA system is implemented. A higher QoR, for example, results in a user obtaining a desired result in less time with fewer interactions and/or communications flowing back-and-forth between the user and the QA system. Achieving a higher QoR may directly result in less network congestion as fewer user interactions (e.g., electronic messages) are necessary, reduced runtime of the QA system to return a usable result to the user, and use of fewer computing resources and/or less power to achieve a given result in part due to the reduced runtime. The practical benefits only grow as the QA systems serve an ever-growing number of users.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

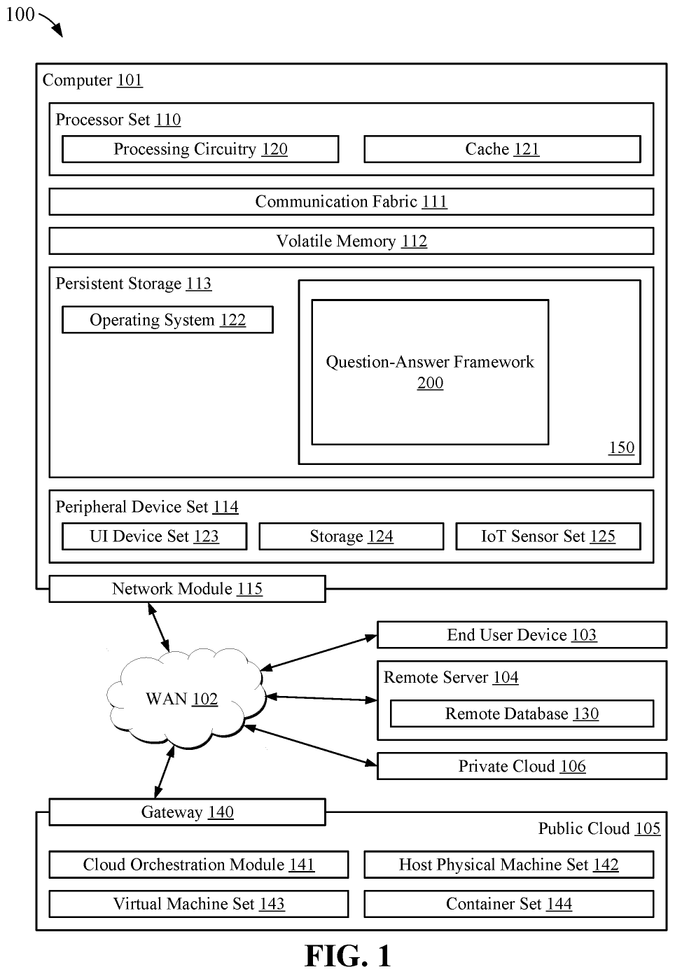

FIG. 1 illustrates an example of a computing system for use with the inventive arrangements described within this disclosure. More particularly, FIG. 1 illustrates an example of a QA system in accordance with one or more embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

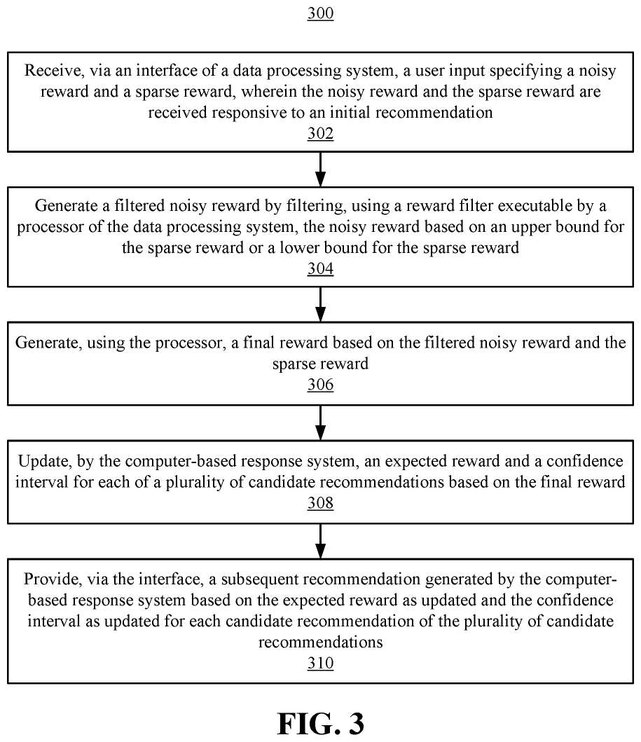

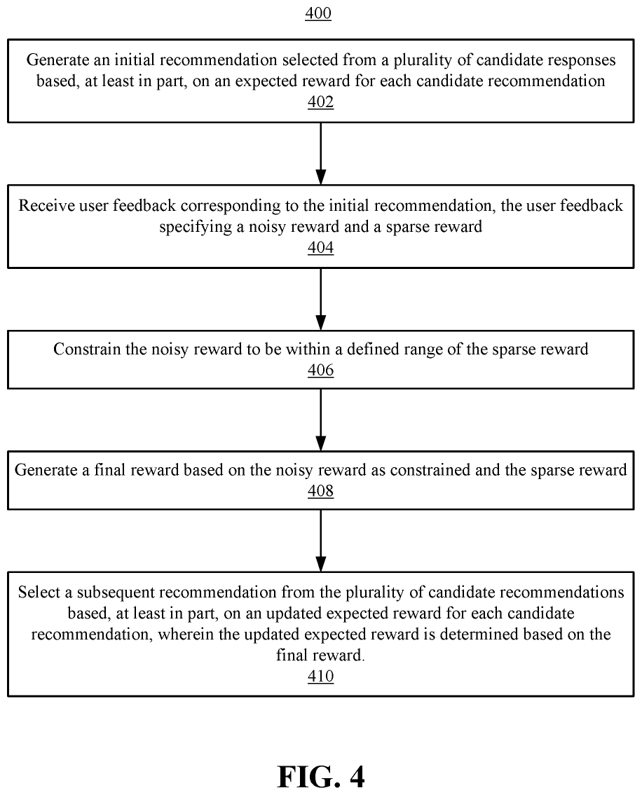

Computing environment 100 contains an example of an environment for the execution of at least some of the computer code in block 150 involved in performing the inventive methods described herein. As illustrated, block 150 may include a QA framework 200 that is executable by computer 101 (e.g., processor set 110 including processing circuitry 120). In executing QA framework 200, computer 101 implements a computer-based QA system that is capable of using a plurality of different types of user feedback, e.g., noisy rewards and/or sparse rewards, in sequentially choosing recommendations from among a plurality of candidate recommendations and presenting the recommendation(s) as selected to a device of a user. Computer 101, in executing QA framework 200, is capable of performing the various methods described herein in connection with FIGS. 3 and 4 and as illustrated in the various examples including pseudo code.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The example of FIG. 1 is not intended to suggest any limitation as to the scope of use or functionality of example implementations described herein. Computer 101 is an example of a data processing system and an example of computer hardware that is capable of performing the various operations described within this disclosure. In this regard, computer 101 may include fewer components than shown or additional components not illustrated in FIG. 1 depending upon the particular type of device and/or system that is implemented. The particular operating system and/or application(s) included may vary according to device and/or system type as may the types of interfaces (e.g., network module 115, network adapter, and/or other input/output interfaces) included. Further, one or more of the illustrative components may be incorporated into, or otherwise form a portion of, another component. For example, a processor may include at least some memory.

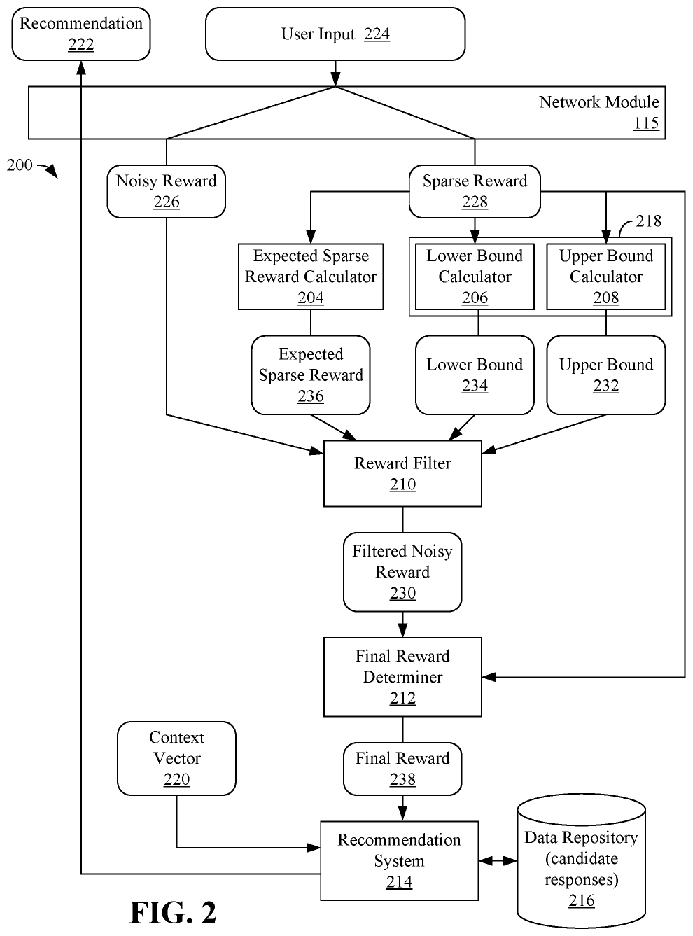

FIG. 2 illustrates an example implementation of QA framework 200 of FIG. 1. QA framework 200 is executed by computer 101 to implement a QA system. The QA system described herein, is capable of operating in real time to provide recommendations as described to EUD 103. For example, QA system may operate in real time to iteratively provide recommendations based on real-time feedback received from users (e.g., EUD 103) and optionally contextual data. In the example, QA framework 200 includes an expected sparse reward calculator 204, a bound calculator 218, a reward filter 210, a final reward determiner 212, and a recommendation system 214.

Recommendation system 214 is capable of selecting a recommendation 222 from a plurality of candidate recommendations stored in data repository 216. Data repository 216 may be stored in storage 124 or remote database 130 of FIG. 1. In one or more embodiments, recommendation system 214 is implemented as an adaptation of an Upper Confidence Bound (UCB)-based system referred to herein as Imputation UCB or “IUCB” that is adapted to utilize both the sparse reward and the noisy reward in selecting recommendations. In one or more other embodiments, recommendation system 214 is implemented as an adaptation of a Linear UCB (LINUCB)-based system referred to as Imputation LINUCB or “ILINUCB” that is adapted to utilize both the sparse reward and the noisy reward in selecting recommendations. As generally understood, LINUCB incorporates contextual data whereas UCB does not. Accordingly, in embodiments of the present invention that utilize the IUCB-based implementation, no contextual data is used. In embodiments of the present invention that utilize the ILINUCB-based implementation, contextual data is used.

FIG. 3 is an example method 300 illustrating certain operative features of the QA system of FIGS. 1 and 2. Referring to FIGS. 2 and 3, method 300 may begin in a state where a user has accessed the QA system via EUD 103. EUD 103 is in communication with the QA system via communication network such as WAN 102.

Method 300 may begin in a state where the QA system has provided one or more recommendations 222 to EUD 103. As an illustrative and non-limiting example, the QA system may be incorporated into a larger computer-based system that provides recommendations or other types of responses to users. For purpose of illustration, the QA system may provide recommendations of content for user consumption, where the items of content selected by the user, as recommended (e.g., movies, songs/audio), are delivered to the user. It should be appreciated, however, that content delivery systems (e.g., streaming systems) are but one type of system in which a QA system may be integrated. A QA system may be used to recommend other products or digital assets to be presented to users. The example systems described herein are not intended to be limiting of the inventive arrangements.

In block 302, the QA system receives a user input 224 via an interface such as network module 115. User input 224 specifies user feedback and includes, or specifies, a noisy reward 226 and a sparse reward 228. Noisy reward 226 and sparse reward 228 may be received responsive to an initial recommendation 222 generated the QA system. For example, the initial recommendation may be selected by recommendation system 214 and output via network module 115.

For purposes of illustration, recommendation system 214 may have already provided one or more recommendations 222 to EUD 103. Recommendation 222 may be selected by recommendation system 214 from the plurality of candidate recommendations stored in data repository 216. As discussed, in embodiments of that utilize the IUCB-based approach, no contextual data is used by recommendation system 214 in selecting a recommendation. In that case, recommendation system 214 selects recommendation 222 from the plurality of candidate recommendations based on an expected reward and an uncertainty as calculated by recommendation system 214 for each of the plurality of candidate recommendations. In the examples described herein, the expected reward is calculated based, at least in part, on both noisy reward 226 and sparse reward 228.

In embodiments that utilize the ILINUCB-based approach, contextual data is used. In the ILINUCB case, recommendation system 214 also uses a context specified by context vector 220 in combination with an expected reward and an uncertainty as calculated by recommendation system 214 for each of the plurality of candidate recommendations. As noted, the expected reward is calculated based, at least in part, on both noisy reward 226 and sparse reward 228. Context vector 220 may be specified as a feature vector having one or more dimensions. Context vector 220, for example, specifies a current state of recommendation system 214.

In the example, sparse reward 228 is provided to bound calculator 218. In one or more example implementations, bound calculator 218 includes a lower bound calculator 206 and an upper bound calculator 208. In general, bound calculator 218 determines a lower bound and an upper bound for sparse reward 228. For example, lower bound calculator 206, based on sparse reward 228 and prior received sparse rewards provided thereto, is capable of determining lower bound 234 for sparse reward 228. Similarly, upper bound calculator 208, based on sparse reward 228 and prior received sparse rewards provided thereto, can determine upper bound 232 for sparse reward 228. In the example, sparse reward 228 is further provided to expected sparse reward calculator 204, which calculates and outputs expected sparse reward 236. Expected sparse reward 236 may be provided to reward filter 210 with upper bound 232, lower bound 234, and noisy reward 226.

In the example, the particular values used by reward filter 210 may be updated for each iteration of the QA system. For example, each time additional user feedback is received specifying a sparse reward, updated versions of expected sparse reward 236, lower bound 234, and upper bound 232 may be calculated and provided to reward filter 210 for filtering or constraining noisy reward 226. Thus, operation of reward filter 210 in filtering noisy reward 226 is adapted over time. For example, expected sparse reward 236 is updated for each iteration. The confidence interval (e.g., upper bound 232 and lower bound 234) is updated for each iteration. Reward filter 210 uses the expected sparse reward as updated and the confidence interval for the sparse reward as updated in performing the filtering for each respective iteration.

By filtering noisy reward 226, the QA system ensures that the noisy reward is inline with expectations and within defined limits. The filtering, as described herein, improves the QoR of the QA system by placing these constraints on the noisy reward, which serve to reduce the “noise” or uncertainty of the noisy reward. This process prevents a noisy reward that is outside of the limits from unduly skewing the selection of a recommendation from the candidate recommendations. The process can lead to marked improvements in QoR as the sparse reward is more readily available to the QA system compared to the sparse reward.

In block 304, the QA system generates a filtered noisy reward 230 by filtering noisy reward 226 based on upper bound 232 for sparse reward 228 or a lower bound 234 for sparse reward 228. More particularly, reward filter 210 generates filtered noisy reward 230. As discussed, the QA system utilizes two types of rewards which include noisy reward 226 and sparse reward 228. In the example, reward filter 210 performs a filter operation by using one reward to filter the other reward. More particularly, reward filter 210 uses sparse reward 228 to filter noisy reward 226.

For purposes of illustration, consider an example in which the QA system provides users with a movie recommendation or a product recommendation. A user selection of the recommendation as presented via EUD 103 (e.g., via a Web page or an application executing on EUD 103) is considered noisy reward 226. The user selection of recommendation 222 as output is considered noisy as the user selection may reveal user interest, but not convey any specific or explicit information as to what the user actually thought of the recommendation. That is, while the recommendation was selected by the user, the QA system has no information as to whether the recommendation provided was relevant to the user, the user query, and/or the current context. Sparse reward 228 explicitly specifies a particular sentiment, e.g., positive or negative, for recommendation 222. Sparse reward 228 also may specify a particular value within a known range of values (e.g., a degree or amount of sentiment). Sparse reward 228 is less “noisy” in that sparse reward 228 conveys more detailed information of user sentiment toward recommendation 222 as output. In this regard, noisy reward 226 is considered a “noisy” proxy for sparse reward 228. Within this disclosure, the term “reward” is used synonymously with a user input and, more particularly, user feedback. As discussed, sparse reward 228 is not always available to the QA system or is available less often than noisy reward 226.

In block 306, the QA system, and more particularly, final reward determiner 212, generates final reward 238. Final reward determiner 212 is capable of generating final reward 238 based on filtered noisy reward 230 and sparse reward 228. In block 308, recommendation system 214 updates an expected reward and a confidence interval for each of the plurality of candidate recommendations as stored in data repository 216 based on final reward 238. With the updates performed in block 308, recommendation system 214 is capable of selecting an updated recommendation 222 (e.g., a further recommendation for a next iteration of the QA system).

In block 310, the QA system provides a subsequent recommendation 222, as selected by recommendation system 214, based on the expected reward as updated and the confidence interval (e.g., uncertainty) as updated for each candidate recommendation of the plurality of candidate recommendations. In the example, recommendation system 214 optionally uses context vector 220 in selecting the next recommendation. For example, in embodiments where recommendation system 214 uses the IUCB-based approach, no contextual data is used. In embodiments where recommendation system 214 uses the ILINUCB-based approach, contextual data, which may be specified as context vector 220 having one or more dimensions, is used.

As discussed, recommendation system 214 is configured to operate in accordance with a multi-armed bandit model using both a noisy reward and a sparse reward obtained from user feedback. Example 1 below illustrates an example implementation of the QA system of FIGS. 1-2 in which K arms within T trials are performed. Playing an arm k yields noisy reward 226, denoted as rₖⁿ, where rₖⁿ∈[0, 1] is sampled according to a fixed unknown distribution v₁ⁿ, . . . , v_{K}ⁿ with mean reward μₖⁿ and standard deviation σₖⁿ. With an unknown probability L, sparse reward 228, denoted as rₖ^{s}, where rₖ^{s}∈[0,1] is sampled according to some fixed unknown distribution v₁^{s}, . . . , v_{K}^{s} with a mean reward μₖ^{s} and standard deviation σₖ^{s}. Though noisy reward 226 and sparse reward 228 are independent, a known gap Ø is assumed between their expectations. The standard deviation of the noisy reward rₖⁿ is higher than the standard deviation of the sparse reward rₖ^{s}.

Accordingly, Example 1 illustrates a stochastic bandit technique that may be implemented by the QA system described in connection with FIGS. 1-3 that uses both sparse and noisy rewards.

### Example 1

| | |
|---|---|
| 1: | Repeat |
| 2: | The user chooses an action k |
| 3: | The reward rₖⁿ(t) is revealed |
| 4: | The reward rₖ^{s}(t) is revealed with probability L |
| 5: | t ← t + 1 |
| 6: | Until t = T |

For purposes of illustration, rₖ(t) denotes the total reward received when playing arm k at time t. μₖ=μₖⁿ+Lμₖ^{s} denotes the expected reward of arm k. The technique illustrated in Example 1 maximizes the expected total reward E[Σₜ₌₁^{T}μₖ₍ₜ₎] during T iterations, where k(t) is the arm played in step t, and E is the expectation taken over the random choice of k(t). An equivalent performance measure is the pseudo regret, which is the amount of total reward lost by a specific algorithm compared to an oracle which plays the (unknown) optimal arm during each iteration.

In the QA system described in connection with FIGS. 1-2, rₖⁿ(t) denotes noisy reward 226 received as user input 224 at time t for arm k, and rₖ^{s}(t) denotes sparse reward 228 received as user input 224 at time t for arm k. nₖⁿ(t) and nₖ^{s}(t) denote the number of times arm k received noisy and sparse rewards, respectively. \hat{μ}ₖ(t) is the estimated mean for arm k at time t, and \hat{μ}ₖ^{s}(t) represents the mean for arm k at time t for the sparse rewards.

Example 2 below illustrates the filtering operation applied to noisy reward 226 by reward filter 210. Within this disclosure, the notation for time (t) dependence is omitted from the mean rewards and confidence intervals in certain examples for ease of illustration. Example 2, as applied by reward filter 210, constrains noisy reward 226 to be within upper bound 232 and lower bound 234 of expected sparse reward 236 for the chosen arm. That is, if noisy reward 226 is within upper bound 232 and lower bound 234 of expected sparse reward 236, noisy reward 226 is left unchanged. In response to determining that noisy reward 226 is less than lower bound 234, reward filter 210 sets noisy reward 226 equal to lower bound 234. In response to determining that noisy reward 226 is greater than upper bound 232, reward filter 210 sets noisy reward 226 equal to upper bound 232.

### Example 2

$$\begin{matrix}{r}_{k}^{n} ( t ) \geq {\hat{μ}}_{k}^{s} - ∅ + {c}_{k}^{s} , & {r}_{k}^{{n}^{′}} ( t ) ← {\hat{μ}}_{k}^{s} - ∅ + {c}_{k}^{s} \\ {r}_{k}^{n} ( t ) \leq {\hat{μ}}_{k}^{s} - ∅ - {c}_{k}^{2} , & {r}_{k}^{{n}^{′}} ( t ) ← {\hat{μ}}_{k}^{s} - ∅ - {c}_{k}^{s} \\ else {r}_{k}^{n} ( t ) ← {r}_{k}^{n} ( t ) & \end{matrix}$$

Example 3 illustrates a pseudo code implementation of the IUCB-based approach as implemented by the QA system described in connection with FIGS. 1-3.

### Example 3

```
  1:  ∀k\hat{μ}ₖ ← 0, \hat{μ}ₖ^{s} ← 0, cₖ ← ∞, cₖ^{s} ← ∞
  2:  for t = 1 to T do
  3:  Predict k ← arg maxₖ (\hat{μ}ₖ + cₖ)
  4:  observe rₖⁿ(t) and if rₖ^{s}(t) exists then h(t) ← 1 else h(t) ← 0
  5:  Compute rₖ^{n′}(t) according to Example 2
  6:  rₖ′(t) ← h(t)rₖ^{s}(t) + rₖ^{n′} (t)
  7:  for all k ∈ [K] do
  8:   ${\hat{μ}}_{k} ← \frac{{\sum }_{t} {r}_{k}^{′} ( t )}{{n}_{k} ( t )} , {\hat{v}}_{k} ← \frac{{\sum }_{t} {( {\hat{μ}}_{k} ( t ) - {r}_{k}^{′} ( t ) )}^{2}}{{n}_{k} ( t )}$
  9:   ${c}_{k} ← \sqrt{\frac{2 {\hat{v}}_{k} log ( t )}{{n}_{k} ( t )}} + \frac{3 log ( t )}{{n}_{k} ( t )}$
10:   ${\hat{μ}}_{k}^{s} ← \frac{{\sum }_{t} {r}_{k}^{s} ( t )}{{n}_{k} ( t )} , {\hat{v}}_{k}^{s} ← \frac{{\sum }_{t} {( {\hat{μ}}_{k}^{s} ( t ) - {r}_{k}^{s} ( t ) )}^{2}}{{n}_{k} ( t )}$
11:   ${c}_{k}^{s} ← \sqrt{\frac{2 {\hat{v}}_{k}^{s} log ( {n}^{s} ( t ) )}{{n}_{k}^{s} ( t )}} + \frac{3 log ( {n}^{s} ( t ) )}{{n}_{k}^{s} ( t )}$
12:  end for
13:  end for
```

In Example 3, line 3 illustrates the start of an iteration of the QA system. For example, line 3 illustrates an initial recommendation, e.g., a prediction of what the user wishes to access as determined by recommendation system 214. In Example 3, cₖ represents the uncertainty (e.g., the confidence interval). Recommendation system 214 is capable of ranking the candidate recommendations based on the expected reward which maximizes a sum of the estimated mean for arm k at time t denoted as \hat{μ}ₖ (e.g., where time is omitted) and the uncertainty cₖ. The particular arm k, e.g., the candidate recommendation with the largest expected reward, is selected and output to EUD 103 as recommendation 222.

At line 4, the QA system receives (e.g., observes) noisy reward 226 and sparse reward 228 if sparse reward 228 is available or provided from in user input 224 as feedback in response to recommendation 222 as selected and provided. At line 5, reward filter 210 performs the filtering of noisy reward 226 as described in connection with Example 2. At line 6, final reward determiner 212 generates the final reward 238 denoted as rₖ′(t) in Example 3. Line 6 illustrates that in the case where sparse reward 228 is available, the function h(t) takes on the value of 1 so that reward filter 210 computes a sum of sparse reward 228 and filtered noisy reward 230 as final reward 238. In the case where sparse reward 228 is not available, the function h(t) takes on the value of 0 so that reward filter 210 outputs filtered noisy reward 230 as final reward 238.

Starting at line 7, various quantities are updated by recommendation system 214 for each arm k (e.g., each candidate recommendation) in preparation for a next iteration of the QA system to provide a next recommendation. As illustrated at line 8, the expected reward is updated based on final reward 238. At line 9, the uncertainty is updated based on final reward 238. At line 10, the expected reward for the sparse reward is updated based on sparse reward. At line 11, the expected upper confidence bound for the sparse reward is calculated. The quantities described in lines 8 and 9 are utilized by recommendation system 214 in selecting a next recommendation to be output for the user from the candidate recommendations. The quantities described in lines 10 and 11 are used by reward filter 210 for the next iteration to perform the reward filtering operation described herein.

In one or more other example implementations, recommendation system 214 is configured to operate in accordance with a contextual, multi-armed bandit model using both a noisy reward and a sparse reward obtained from user feedback. Example 4 below illustrates an example of the contextual, multi-armed bandit model involving both noisy and sparse rewards as may be implemented by the QA system of FIGS. 1-2.

In Example 4, at each time t∈[T], the system is presented with a context vector 220, denoted as xₜ∈ [symbol] ^{d}, where ∥xₜ∥₂≤1, and must choose an arm k∈[K]. The system operates under the linear realizability assumption, i.e., that for all k∈[K], there exists unknown weight vectors θₖ∈ [symbol] ^{d} with ∥θₖ∥₂≤1 so that [symbol] t:∈[rₖ(t)xₜ]=θₖ^{τ}xₜ=θₖ^{nτ}xₜ+Lθₖ^{sτ}xₜ, where θₖⁿ and θₖ^{s} are respectively the optimal parameter for the noisy reward rₖⁿ and the sparse reward rₖ^{s}. Accordingly, Example 4 below illustrates a contextual bandit technique involving both sparse and noisy rewards that may be implemented by the QA system described in connection with FIGS. 1-3.

### Example 4

| | |
|---|---|
| 1: | Repeat |
| 2: | (xₜ,rₜ) is drawn according to some distribution |
| 3: | xₜ is revealed |
| 4: | User chooses action k |
| 5: | The reward rₖⁿ(t) is revealed |
| 6: | The reward rₖ^{s}(t) is revealed with probability L |
| 7: | Parameters θₖ(t) are updated |
| 8: | t ← t + 1 |
| 9: | Until t = T |

In a conventional LINUCB-based system, an online ridge regression is applied to incoming data to obtain an estimate of the coefficients θₖ for k=1, . . . , K. At each time step t, the LINUCB policy selects the arm with the highest upper confidence bound of the reward k(t)=argmaxₖ(θₖ^{τ}xₜ+cₖ), where cₖ=α\sqrt{xₜ^{τ}Aₖ⁻¹xₜ} is the standard deviation of the corresponding reward scaled by exploration-exploitation trade-off parameter a (chosen a priori) and Aₖ is the covariance of the k-th arm context. Unlike conventional LINUCB-based systems, QA systems implemented as described herein are adapted to utilize both the noisy rewards rₖⁿ∈ [symbol] and the sparse rewards rₖ^{s}∈ [symbol] .

Example 5 below illustrates another example filtering operation applied to noisy reward 226 by reward filter 210 in the case of an ILINUCB-based implementation of the QA system involving contextual data. Example 5, as applied by reward filter 210, constrains noisy reward 226 to be within upper bound 232 and lower bound 234 of the expected sparse reward 236 for the chosen arm. The filtering illustrated in Example 5 is substantially similar to the filtering illustrated in Example 2. That is, if noisy reward 226 is within upper bound 232 and lower bound 234 of the expected sparse reward 236, noisy reward 226 is left unchanged. In response to determining that noisy reward 226 is less than lower bound 234, reward filter 210 sets noisy reward 226 equal to lower bound 234. In response to determining that noisy reward 226 is greater than upper bound 232, reward filter 210 sets noisy reward 226 equal to upper bound 232.

### Example 5

$$\begin{matrix}{r}_{k}^{n} ( t ) \geq {θ}_{k}^{s ⊤} {x}_{t} - ∅ + {c}_{k}^{s} , & {r}_{k}^{{n}^{′}} ( t ) ← {θ}_{k}^{s ⊤} {x}_{t} - ∅ + {c}_{k}^{s} \\ {r}_{k}^{n} ( t ) \leq {θ}_{k}^{s ⊤} {x}_{t} - ∅ - {c}_{k}^{s} , & {r}_{k}^{{n}^{′}} ( t ) ← {θ}_{k}^{s ⊤} {x}_{t} - ∅ - {c}_{k}^{s} \\ else {r}_{k}^{n} ( t ) ← {r}_{k}^{n} ( t ) & \end{matrix}$$

Example 6 illustrates a pseudo code implementation of the ILINUCB-based approach as implemented by the QA system described in connection with FIGS. 1-3 in which contextual data is available.

### Example 6

| | |
|---|---|
| 1: | Input: α |
| 2: | ∀k ∈ [K], Aₖ ← I_{d+1}, Sₖ ← I_{d+1}, bₖ ← 0_{d+1}, bₖ^{s} ← 0_{d+1}, θₖ ← 0_{d+1}, |
| | θₖ^{s} ← 0_{d+1} |
| 3: | for t = T₀ + 1 to T do |
| 4: | observe xₜ |
| 5: | for all k ∈ [K] do |
| 6: | θₖ ← Aₖ⁻¹ * bₖ , cₖ ← α\sqrt{xₜ^{T}Aₖ⁻¹xₜ} |
| 7: | θₖ^{s} ← Sₖ⁻¹ * bₖ^{s}, cₖ^{s} ← α\sqrt{xₜ^{T}Sₖ⁻¹xₜ} |
| 8: | end for |
| 9: | play arm k = arg maxₖ(θₖ^{T}xₜ + cₖ) |
| 10: | observe rₖⁿ(t) and if rₖ^{s}(t) exists then h(t) ← 1 else h(t) ← 0 |
| 11: | Compute rₖⁿ′(t) according to Example 5 |
| 12: | r′ₖ(t) ← h(t)rₖ^{s}(t) + rₖⁿ′(t) |
| 13: | Sₖ ← Sₖ + h(t)xₜxₜ^{T}, bₖ^{s} ← bₖ^{s} + h(t)rₖ^{s}(t)xₜ |
| 14: | Aₖ ← Aₖ + xₜxₜ^{T} |
| 15: | bₖ ← bₖ + r′ₖ(t) xₜ |
| 16: | end for |

In Example 6, line 4 illustrates the start of an iteration of the QA system. For example, line 4 illustrates an initial recommendation, e.g., a prediction of what the user wishes to access as determined by recommendation system 214. In Example 6, cₖ represents the uncertainty (e.g., the confidence interval). Recommendation system 214 is capable of ranking the candidate recommendations based on the expected reward which maximizes a sum of the estimated mean for arm k at time t denoted as \hat{μ}ₖ (e.g., where time is omitted) and the uncertainty cₖ. The particular arm k, e.g., the candidate recommendation with the largest expected reward is selected and output to EUD 103.

At line 10, the QA system receives (e.g., observes) noisy reward 226 and sparse reward 228 if sparse reward 228 is available or provided from the user as feedback in response to the recommendation selected and provided. At line 11, reward filter 210 performs the filtering of noisy reward 226 as described in accordance with Example 5. At line 11, final reward determiner 212 generates the final reward 238 denoted as rₖ′(t). Line 12 illustrates that in the case where a sparse reward is available, the function h(t) takes on the value of 1 so that reward filter 210 computes a sum of sparse reward 228 and filtered noisy reward 230 as final reward 238. In the case where a sparse reward is not available, the function h(t) takes on the value of 0 so that reward filter 210 outputs filtered noisy reward 230 as final reward 238.

Starting at line 13, various quantities are updated by recommendation system 214 for each arm k (e.g., each candidate recommendation) in preparation for a next iteration of the QA system to provide a next recommendation. As illustrated, at line 13, Sₖ, which is the covariance matrix for the sparse reward that is used to estimate the learning parameter for the sparse reward, is updated for each arm. At line 14, Aₖ, e.g., the covariance of the k-th arm context, is updated for each arm. At line 15, bₖ, which is a vector that is used to collect and some up the new reward and the previous rewards, is updated for each arm.

FIG. 4 is another example method 400 illustrating certain operative features of the QA system described in connection with FIGS. 1 and 2. In block 402, the QA system generates an initial recommendation selected from a plurality of candidate recommendations. The recommendation, as generated, may be determined based, at least in part, on an expected reward for each of the candidate recommendations. As discussed, recommendation system 214 is capable of selecting a recommendation from those stored in data repository 216 and output the selected recommendation by way of an interface such as network module 115 to EUD 103. The recommendations may be selected using the IUCB-based approach or the ILINUCB-based approach.

In block 404, the QA system receives user feedback corresponding to the initial recommendation of block 402. The user feedback may be received via the interface (e.g., network module 115). The user feedback, as received, specifies noisy reward 226 and sparse reward 228. In block 406, the QA system is capable of constraining noisy reward 226 to be within a defined range of sparse reward 228 and, more particularly, within a defined range of expected sparse reward 236. For example, reward filter 210 is capable of filtering, or constraining, noisy reward 226 by updating noisy reward 226 to be equal to lower bound 234 of sparse reward 228 in response to determining that noisy reward 226 is less than lower bound 234 of sparse reward 228. That is, reward filter outputs filtered noisy reward 230 set to lower bound 234. Reward filter 210 is capable of constraining noisy reward 228 by updating noisy reward 228 to be equal to upper bound 232 of sparse reward 228 in response to determining that noisy reward 226 is greater than upper bound 232 of sparse reward 228. That is, reward filter outputs filtered noisy reward 230 set to upper bound 232. In the case where noisy reward 226 is within the defined range, noisy reward 226 may be used unaltered. That is, filtered noisy reward 230 is equal to noisy reward 226 as originally received.

The QA system is capable of generating a recommendation for each of a plurality of iterations. For each iteration, the lower bound of the sparse reward is updated and the upper bound of the sparse reward is updated. Accordingly, the constraining or filtering described in connection with block 406 and as performed by reward filter 210 may be implemented using the updated upper bound and updated lower bound for each respective iteration. For example, the constraining constrains the noisy reward during each iteration using the lower bound or the upper bound as updated for that iteration.

In block 408, the QA system is capable of generating a final reward based on the noisy reward as constrained (e.g., filtered noisy reward 230) and sparse reward 228. As discussed, the QA system is capable of generating a recommendation for each of a plurality of iterations. A sparse reward may not be received for each iteration of the QA system. For each iteration of the QA system in which a sparse reward is not received, the noisy reward, as constrained (e.g., filtered noisy reward 230), is used as the final reward.

In block 410, the QA system selects a subsequent recommendation from the plurality of candidate recommendations based, at least in part, on an updated expected reward for each candidate recommendation. The updated expected reward is determined based on the final reward as computed in block 408. The subsequent recommendation (an updated version of recommendation 222) may be output to EUD 103 for use by the user.

The example of FIG. 4 may be used in implementations in which no contextual data is available and also in cases where contextual data is available. Appreciably, in cases where contextual data is available, e.g., as context vector 220, the recommendations selected, e.g., the initial recommendation and the subsequent recommendation, are selected also based on the contextual data.

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “data processing system” or “computer” means one or more hardware systems configured to process data, each hardware system including at least one processor and memory, wherein the processor is programmed with computer-readable instructions that, upon execution, initiate operations.

As defined herein, the terms “includes.” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “in response to” or “responsive to,” depending upon the context. Thus, the phrase “if it is determined” or “if [a stated condition or event] is detected” may be construed to mean “in response to determining” or “in response to detecting [the stated condition or event]” or “responsive to detecting [the stated condition or event].”

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, via an interface of a data processing system, a user input specifying a noisy reward and a sparse reward, wherein the noisy reward and the sparse reward are received responsive to an initial recommendation generated by a computer-based recommendation system;
generating a filtered noisy reward by filtering, using a reward filter executable by a processor of the data processing system, the noisy reward based on an upper bound for the sparse reward or a lower bound for the sparse reward;
generating, using the processor, a final reward based on the filtered noisy reward and the sparse reward;
updating, by the computer-based recommendation system, an expected reward and a confidence interval for each of a plurality of candidate recommendations based on the final reward; and
providing, via the interface, a subsequent recommendation generated by the computer-based recommendation system based on the expected reward as updated and the confidence interval as updated for each candidate recommendation of the plurality of candidate recommendations.

2. The method of claim 1, wherein the filtering comprises at least one of:
in response to determining that the noisy reward is less than the lower bound of the sparse reward, updating the noisy reward to be equal to the lower bound of the sparse reward; or
in response to determining that the noisy reward is greater than the upper bound of the sparse reward, updating the noisy reward to be equal to the upper bound of the sparse reward.

3. The method of claim 1, wherein the generating the final reward based on the filtered noisy reward and the sparse reward comprises:
summing the final reward with the filtered noisy reward.

4. The method of claim 1, further comprising:
generating a recommendation for each of a plurality of iterations;
wherein for one or more of the plurality of iterations, a sparse reward is not received; and
for each iteration in which a sparse reward is not received, using the noisy reward, as filtered, as the final reward.

5. The method of claim 1, further comprising:
updating an expected sparse reward for each iteration;
updating a confidence interval for the sparse reward for each iteration; and
using the expected sparse reward as updated and the confidence interval for the sparse reward as updated in performing the filtering for each respective iteration.

6. The method of claim 1, wherein each of the initial recommendation and the subsequent recommendation is generated by the computer-based recommendation system based on a respective context vector.

7. A system, comprising:
one or more processors configured to execute operations including:
receiving, via an interface of the system, a user input specifying a noisy reward and a sparse reward, wherein the noisy reward and the sparse reward are received responsive to an initial recommendation generated by a computer-based recommendation system;
generating a filtered noisy reward by filtering, using a reward filter executable by the one or more processors, the noisy reward based on an upper bound for the sparse reward or a lower bound for the sparse reward;
generating, using the one or more processors, a final reward based on the filtered noisy reward and the sparse reward;
updating, by the computer-based recommendation system, an expected reward and a confidence interval for each of a plurality of candidate recommendations based on the final reward; and
providing, via the interface, a subsequent recommendation generated by the computer-based recommendation system based on the expected reward as updated and the confidence interval as updated for each candidate recommendation of the plurality of candidate recommendations.

8. The system of claim 7, wherein the filtering comprises at least one of:
in response to determining that the noisy reward is less than the lower bound of the sparse reward, updating the noisy reward to be equal to the lower bound of the sparse reward; or
in response to determining that the noisy reward is greater than the upper bound of the sparse reward, updating the noisy reward to be equal to the upper bound of the sparse reward.

9. The system of claim 7, wherein the generating the final reward based on the filtered noisy reward and the sparse reward comprises:
summing the final reward with the filtered noisy reward.

10. The system of claim 7, wherein the one or more processors are configured to execute operations further comprising:
generating a recommendation for each of a plurality of iterations;
wherein for one or more of the plurality of iterations, a sparse reward is not received; and
for each iteration in which a sparse reward is not received, using the noisy reward, as filtered, as the final reward.

11. The system of claim 7, wherein the one or more processors are configured to execute operations further comprising:
updating an expected sparse reward for each iteration;
updating a confidence interval for the sparse reward for each iteration; and
using the expected sparse reward as updated and the confidence interval for the sparse reward as updated in performing the filtering for each respective iteration.

12. The system of claim 7, wherein each of the initial recommendation and the subsequent recommendation is generated by the computer-based recommendation system based on a respective context vector.

13. A computer program product comprising one or more computer readable storage mediums having program instructions embodied therewith, wherein the program instructions are executable by a data processing system to cause the data processing system to execute operations comprising:
receiving, via an interface of the data processing system, a user input specifying a noisy reward and a sparse reward, wherein the noisy reward and the sparse reward are received responsive to an initial recommendation generated by a computer-based recommendation system;
generating a filtered noisy reward by filtering, using a reward filter executable by the data processing system, the noisy reward based on an upper bound for the sparse reward or a lower bound for the sparse reward;
generating, by the data processing system, a final reward based on the filtered noisy reward and the sparse reward;
updating, by the computer-based recommendation system, an expected reward and a confidence interval for each of a plurality of candidate recommendations based on the final reward; and
providing, via the interface, a subsequent recommendation generated by the computer-based recommendation system based on the expected reward as updated and the confidence interval as updated for each candidate recommendation of the plurality of candidate recommendations.

14. The computer program product of claim 13, wherein the filtering comprises at least one of:
in response to determining that the noisy reward is less than the lower bound of the sparse reward, updating the noisy reward to be equal to the lower bound of the sparse reward; or
in response to determining that the noisy reward is greater than the upper bound of the sparse reward, updating the noisy reward to be equal to the upper bound of the sparse reward.

15. The computer program product of claim 13, wherein the generating the final reward based on the filtered noisy reward and the sparse reward comprises:
summing the final reward with the filtered noisy reward.

16. The computer program product of claim 13, wherein the program instructions are executable by the data processing system to cause the data processing system to execute operations comprising:
generating a recommendation for each of a plurality of iterations;
wherein for one or more of the plurality of iterations, a sparse reward is not received; and
for each iteration in which a sparse reward is not received, using the noisy reward, as filtered, as the final reward.

17. The computer program product of claim 13, wherein the program instructions are executable by the data processing system to cause the data processing system to execute operations comprising:
updating an expected sparse reward for each iteration;
updating a confidence interval for the sparse reward for each iteration; and
using the expected sparse reward as updated and the confidence interval for the sparse reward as updated in performing the filtering for each respective iteration.

18. The computer program product of claim 13, wherein each of the initial recommendation and the subsequent recommendation is generated by the computer-based recommendation system based on a respective context vector.

19. A method, comprising:
generating, by a processor, an initial recommendation selected from a plurality of candidate recommendations based, at least in part, on an expected reward for each candidate recommendation;
receiving, by the processor, user feedback corresponding to the initial recommendation, the user feedback specifying a noisy reward and a sparse reward;
constraining, by the processor, the noisy reward to be within a defined range of the sparse reward;
generating, by the processor, a final reward based on the noisy reward as constrained and the sparse reward; and
selecting, by the processor, a subsequent recommendation from the plurality of candidate recommendations based, at least in part, on an updated expected reward for each candidate recommendation, wherein the updated expected reward is determined based on the final reward.

20. The method of claim 19, further comprising:
generating a recommendation for each of a plurality of iterations;
wherein for one or more of the plurality of iterations, a sparse reward is not received; and
for each iteration in which a sparse reward is not received, using the noisy reward, as constrained, as the final reward.

21. The method of claim 19, wherein the constraining comprises at least one of:
in response to determining that the noisy reward is less than a lower bound of the sparse reward, updating the noisy reward to be equal to the lower bound of the sparse reward; or
in response to determining that the noisy reward is greater than an upper bound of the sparse reward, updating the noisy reward to be equal to the upper bound of the sparse reward.

22. The method of claim 21, wherein:
for each of a plurality of iterations, the lower bound of the sparse reward is updated and the upper bound of the sparse reward is updated; and
the constraining constrains the noisy reward during each iteration using the lower bound or the upper bound as updated for the iteration.

23. The method of claim 19, wherein each of the initial recommendation and the subsequent recommendation is generated, by the processor, based on a respective context vector.

24. A system, comprising:
one or more processors configured to execute operations including:
generating an initial recommendation selected from a plurality of candidate recommendations based, at least in part, on an expected reward for each candidate recommendation;
receiving user feedback corresponding to the initial recommendation, the user feedback specifying a noisy reward and a sparse reward;
constraining, by the processor, the noisy reward to be within a defined range of the sparse reward;
generating a final reward based on the noisy reward as constrained and the sparse reward; and
selecting a subsequent recommendation from the plurality of candidate recommendations based, at least in part, on an updated expected reward for each candidate recommendation, wherein the updated expected reward is determined based on the final reward.

25. The system of claim 24, wherein the constraining comprises at least one of:
in response to determining that the noisy reward is less than a lower bound of the sparse reward, updating the noisy reward to be equal to the lower bound of the sparse reward; or
in response to determining that the noisy reward is greater than an upper bound of the sparse reward, updating the noisy reward to be equal to the upper bound of the sparse reward.
